(19) United States
(12) Patent Application Publication
(10) Pub. No.: US 2006/0034076 A1
(43) Pub. Date: Feb. 16, 2006

(54) Direct-light illuminating unit of LCD module having diffuser designated by surface function

(76) Inventors: Chih-Kuang Chang, Taichung City (TW); John Chungteh Pan, Taichung City (TW); Nai-Yang Chang, Taichung City (TW)

Correspondence Address: BIRCH STEWART KOLASCH & BIRCH, PO BOX 747, FALLS CHURCH, VA, 22040-0747, US

(21) Appl. No.: 10/916,538

(22) Filed: Aug. 12, 2004

(51) Int. Cl. F21V 15/00

(52) U.S. Cl. 362/223

(57) ABSTRACT

A direct-light illuminating unit has a case on which a reflector, lamps and a diffuser are configured in order. The diffuser has a transparent substrate, onto which, either side of the surfaces may have predetermined optical patterns being formed into a specific profile. The optical pattern is composed of a plurality of optical transform units. The specific surface profile redistributes the incident light and resulted in an averaged emitting light across the illuminating area. The surface profile is formed according to a predetermined surface function and the parameters of the function include the relative positions of the optical components of the illuminating unit and given constrains. The optical transform units on the surface have predetermined depths, widths and arrangement pattern that alter the onward direction and strength of incident rays and result in redistributed emitting light across the illuminating area with uniform luminosity.

### BACKGROUND OF THE INVENTION

1. Field of the Invention

The present invention relates generally to a liquid crystal display (LCD) module, and more particularly to a direct-light illuminating unit, in which a sheet of light diffuser is designated by a surface function to meet the very requirement of the illuminating unit.

2. Description of the Related Art

Liquid crystal displays (LCDs) have been applied to computer monitors, video devices, consumer electronics and the like. A conventional LCD module is mainly composed of a liquid crystal panel and an illuminating backlight unit. The backlight unit provides illumination to the liquid crystal panel so that the panel can show predetermined images. The conventional illuminating backlight unit is typically classified into so called direct-light illuminating unit and so called edge-light illuminating unit.

Typically, the direct-light illuminating unit has a case on which a reflector, lamps and a sheet of diffuser are configured in order. The lamps radiate light onto both of the diffuser and the reflector. The reflector reflects the backward directed rays from the lamps toward the diffuser in the front and the diffuser allows the rays both from the lamps and from the reflector transmitting through and diffuses the light that consequently forms a diffusive light-emitting surface for the liquid crystal panel.

The conventional diffuser has a transparent substrate in which organic fillers are uniformly distributed in the substrate to deflect or reflect the light. In consequence, random and complex light transmitting passages are formed along the thickness of the substrate. The fillers in the substrate deflect the directions of light that prevent light from going through straight and thus diffuse the light, as well as reflect part of the incident light back to the cavity between the reflector and diffuser. The result is a uniform transmitting light emit from the diffuser. Unfortunately, this ray averaging process also decades the amount of light that could be possibly transmitted through, by means of absorption mechanisms due to quantum effects.

### SUMMARY OF THE INVENTION

The primary objective of the present invention is to provide a direct-light illuminating unit as a LCD backlight, which has higher light emitting efficiency.

According to the objective of the present invention, a direct-light illuminating unit comprises a case on which a reflector, at least a lamp and a sheet of diffuser are configured in order. The diffuser comprises of a transparent substrate, onto which, either side of the surfaces may have predetermined optical patterns being formed into a specific profile. The optical pattern is composed of a plurality of optical transform units. The specific surface profile alters the onward direction and strength of incident rays and result in redistributed emitting light across the illuminating area with uniform luminosity.

### BRIEF DESCRIPTION OF THE DRAWINGS

FIG. 1 is an exploded view of a first preferred embodiment of the present invention;

FIG. 2 is a sectional view of the first preferred embodiment of the present invention;

FIG. 3 is an enlarged sectional view of the diffuser of the first preferred embodiment of the present invention;

FIG. 4 is an enlarged perspective view in part of the diffuser of the first preferred embodiment of the present invention;

FIG. 5 is a diagram, showing the angular distribution of energy of red light, blue light and green light after passing through the diffuser of the first preferred embodiment of the present invention;

FIG. 6 is an enlarged perspective view in part of the diffuser of a second preferred embodiment of the present invention;

FIG. 7 is a diagram, showing the angular distribution of energy of red light, blue light and green light after passing through the diffuser of the second preferred embodiment of the present invention;

FIG. 8 is an enlarged perspective view in part of the diffuser of a third preferred embodiment of the present invention, and

FIG. 9 is an enlarged perspective view in part of the diffuser of a fourth preferred embodiment of the present invention.

### DETAILED DESCRIPTION OF THE INVENTION

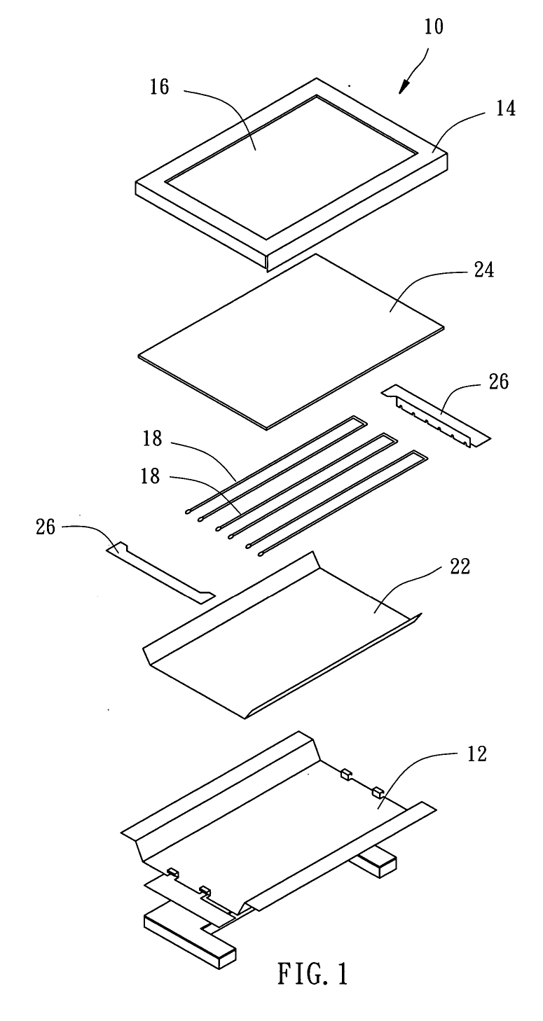

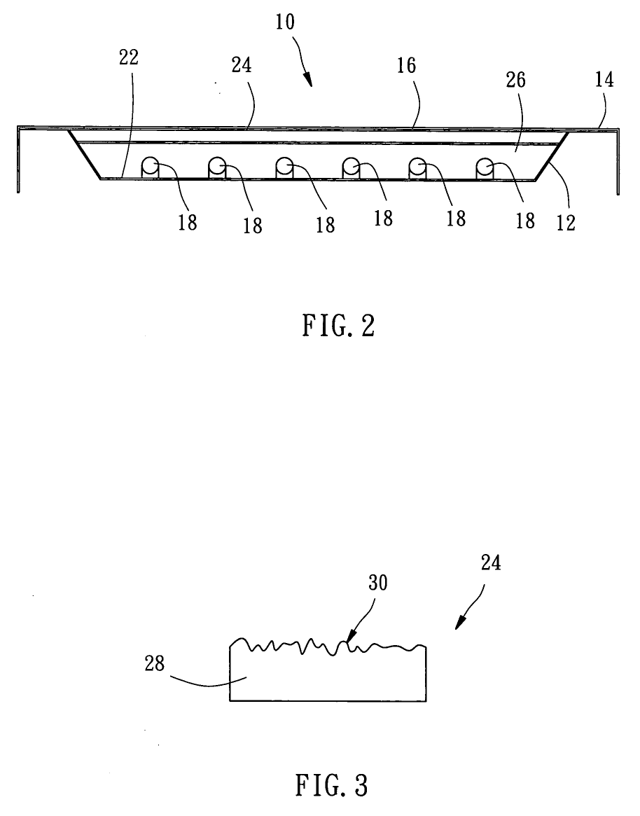

As shown in FIG. 1, the first preferred embodiment of the present invention provides a direct-light illuminating backlight unit 1 for a LCD module, which mainly comprises:

A case 10 is consisted of a back cover plate 12 and a upper frame 14 and in the center of the upper frame 14 is a window opening 16.

Three lamps 18 are Cold Cathode Fluorescent Lamps (CCFLs). Such lamps have advantages of smaller diameter, longer life and higher illuminating performance and so on. Each lamp 18 is bent from a straight tube of lamp into a substantial U-shape. The lamps 18 are firmly mounted on the back cover plate 12 of the case 10 and electrically connected to transformers or transformer output channels of an inverter (not shown), which is mounted on the case 10, to provide the lamps 18 with high-voltage AC electricity. In practice, the numbers and the specification of the lamps and the transformers are determined according to the requirements of the illuminating backlight unit.

A reflector film 22 is attached on the back cover plate 12 of the case 10 below the lamps 18.

A diffuser sheet 24 is mounted on the back cover plate 12 of the case above the lamps 18.

Two side frames 26 are mounted at opposite ends of the lamps 18 to fix the lamps 18.

As shown in FIG. 3, the diffuser sheet 24 has a transparent substrate 28, on a surface of which is formed with a surface profile 30.

The surface profile 30 has a predetermined pattern and the pattern is determined from a predetermined surface function. The parameters of the function are the positions of the diffuser sheet 24 related to the lamps 18 and the reflector film 22 etc. and the given constrains, such as the specification of luminance and viewing angle etc. These parameters are calculated via numerical analysis, namely, Project on Convex Set (POCS) method, and are optimized by adjusting the weighting factor of transfer function through recursion.

The surface profile 30 of the diffuser sheet 24 is designated to change the propagation of the light. The surface profile 30 is provided with a plurality of cavities with various depths and widths, called optical transform units 31, on the surface of the substrate 28. The degree of change of light propagation profile through the diffuser sheet is related to the size of optical transform units.

If the pixels of the optical transform units 31 of the surface profile 30 are smaller than a certain characteristic size (relative to the wavelength of light), the propagation of light is a non-linear behavior rather than linear behavior, which can be governed by geometric rules. The governing equations of non-linear optics can be solved by Fourier Transfer method.

Because the optical components of the illuminating backlight unit are nottime dependent, so that all optical components are integrated in design and in fabrication to reduce the space of system and the difficulty of assembly. And the efficiency of light transmittance is high while the light diffusion capability is also high, without scarifying transmittance.

According to our study, the Y-G Algorithm gives a surface profile, which approximates the real phase as possible. The ways of fabrication of the surface profile 30 could be done by etching method, printing method, electroforming method and other suitable methods.

The surface profile 30 of the diffuser sheet 24 has phases with various depths and widths. The conventional method averages the phases to approximate the real phases, so that there are only a few of constant depths of the phases. The present invention assumes that each order has individual depth and width, so that it would get a well far-field diffraction under a predetermined depth and width. The formula for calculation the phase is hereunder:

$$phase = ( \frac{x}{λ / n} + \frac{d - x}{λ} ) \times 2 π$$

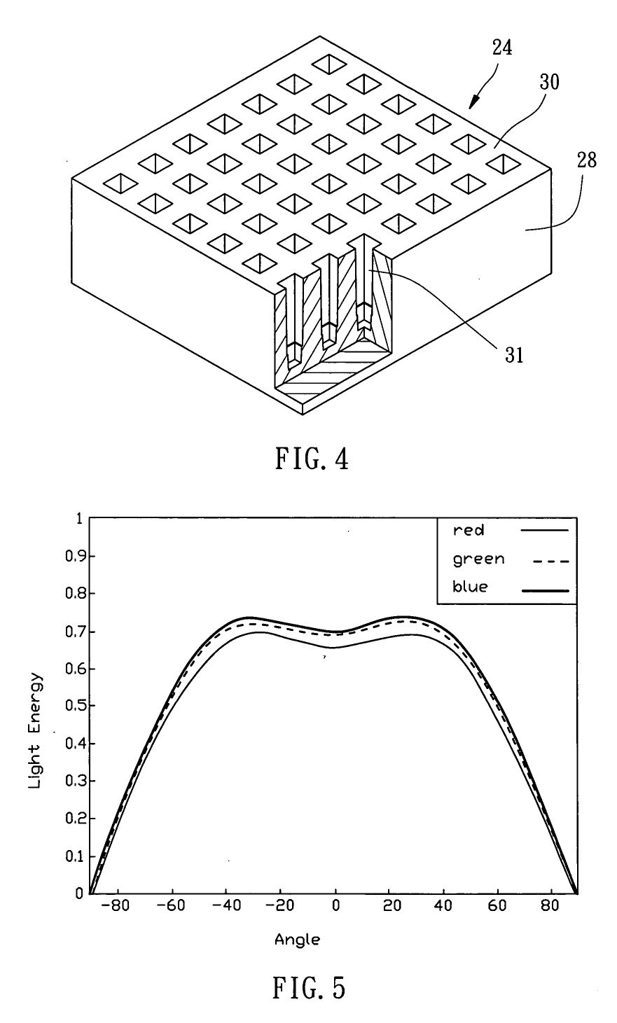

FIG. 4 shows the surface profile 30 of the diffuser sheet 24 under the microscope. The substrate 28 is made of polymer with a thickness about 2 mm. The surface profile 30 is consisted of a plurality of the optical transform units 31 and each optical transform unit 31 has a predetermined depth and a predetermined width. The widths of the optical transform units 31 are in a range of between 0.5 μm and 10 μm. The depth of the optical transform units 31 is in a range of between 1 λ and 20 λ.

FIG. 5 is a diagram showing the angular distribution of energy of which are the exit strength of red light, green light and blue light emitting from the diffuser sheet 24 of the present invention. According to FIG. 5, the red light, the green light and the blue light are well diffused (averaged) for an viewing angle up to +/−60 degrees, and the transmittance level is high (greater than 60%). The red light has a little worse performance in transmittance when emitting through the PMMA substrate 28 than the green light and the blue light.

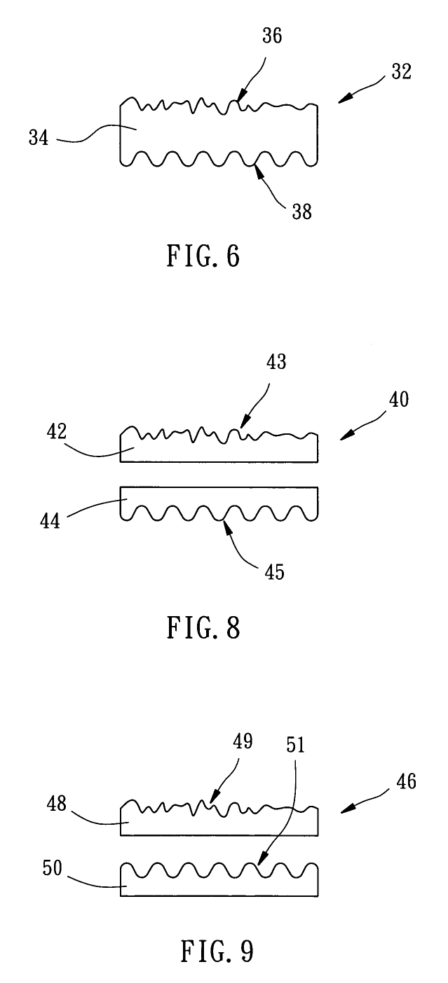

As shown in FIG. 6, a diffuser sheet 32 of the second preferred embodiment of the present invention has a transparent substrate 34 and the substrate 34 has two surface profiles 36 and 38 on opposite surfaces thereof respectively. The surface profiles 36 and 38 each have a predetermined pattern respectively. The ways of molding the surface profiles are as same as the first preferred embodiment disclosed.

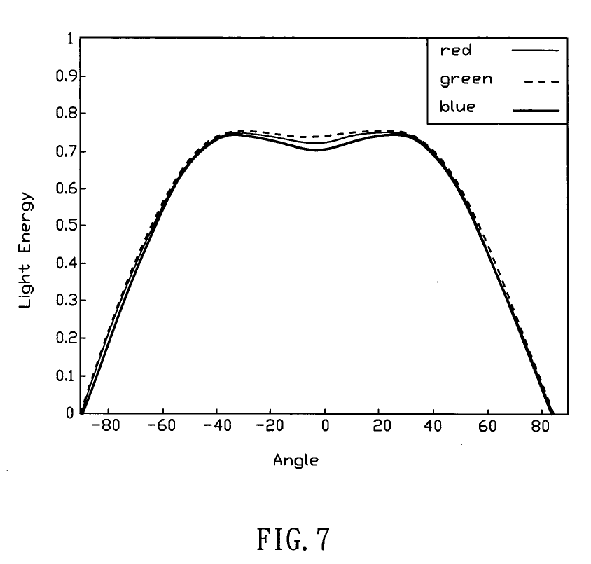

FIG. 7 is a diagram showing the angular distribution of energy of red light, green light and blue light exiting from the diffuser sheet 32. The diagram shows the transmittance of the red light to be over 70% after propagating through surface profiles 36 and 38.

FIG. 8 shows a diffuser 40 of the third preferred embodiment of the present invention having two substrates 42 and 44, on each of which a surface profile 43 and 45 is formed. The surface profile 43 of the substrate 42 is designated to face the lamps (not shown) and the other surface profile 45 of the substrate 44 is designated to face a liquid crystal panel (not shown). In other words, the surface profiles 43 and 45 of the substrates 42 and 44 are positioned back-to-back, facing opposite directions.

FIG. 9 shows a diffuser 46 of the fourth preferred embodiment of the present invention, which is similar to the third preferred embodiment, having two substrates 48 and 50, on each of which a surface profile 49 and 51 is formed. The surface profiles 49 and 51 of the substrates 48 and 50 are facing the same direction (either orienting the lamps or orienting the liquid crystal panel).

What is claimed is:

1. A direct light illuminating unit of a LCD module, comprising:
a case;
at least a lamp mounted on the case to provide light;
a reflector mounted on the case, behind the lamp, and
a diffuser mounted on the case, above the lamp;
wherein the diffuser is constituted at least a substrate, on a surface of which a surface profile is formed directly and the surface profile has a plurality of optical transform units to form a predetermined pattern and the optical transform units each have a predetermined depth and a predetermined width respectively to change paths of the light transmitting through the surface profile.

2. The illuminating unit as defined in claim 1, wherein the substrate is formed with two surface profiles on opposite surfaces respectively.

3. The illuminating unit as defined in claim 1, wherein the diffuser has two substrates, each of which is formed with a surface profile respectively.

4. The illuminating unit as defined in claim 3, wherein one of the substrate has the surface profile on the surface orientating the lamp and the other substrate has the surface profile orientating at opposite orientation from the lamp.

5. The illuminating unit as defined in claim 3, wherein both of the surface profiles of the substrates orientate at the lamp.

6. The illuminating unit as defined in claim 3, wherein both of the surface profiles of the substrates orientate at opposite orientation from the lamp.

7. The illuminating unit as defined in claim 1, wherein the surface profile has the optical transform units with the widths thereof less than 10 μm to diffract the light emitting through the surface profile.

8. The illuminating unit as defined in claim 1, wherein the surface profile has the optical transform units with the depth in a range of between 1 λ and 20 λ.

9. The illuminating unit as defined in claim 1, wherein the pattern of the surface profile of the substrate is calculated by a predetermined function subjecting to relative positions of the lamp, the reflector film and the diffuser.
